(19) United States
(12) Patent Application Publication
(10) Pub. No.: US 2019/0273578 A1
(43) Pub. Date: Sep. 5, 2019

(54) METHODS OF ADAPTIVE TRANSMISSION IN LOW LATENCY SCENARIOS IN NEW RADIO (NR) SYSTEMS

(71) Applicants: Jeongho Jeon, San Jose, CA (US); Gang Xiong, Beaverton, OR (US); Bishwarup Mondal, San Ramon, CA (US); Carlos Aldana, Santa Clara, CA (US); Hwan-Joon Kwon, Portland, OR (US); Alexei Davydov, Nizhny Novgorod (RU); Seau S. Lim, Swindon (GB)

(72) Inventors: Jeongho Jeon, San Jose, CA (US); Gang Xiong, Beaverton, OR (US); Bishwarup Mondal, San Ramon, CA (US); Carlos Aldana, Santa Clara, CA (US); Hwan-Joon Kwon, Portland, OR (US); Alexei Davydov, Nizhny Novgorod (RU); Seau S. Lim, Swindon (GB)

(21) Appl. No.: 16/418,768

(22) Filed: May 21, 2019

Related U.S. Application Data
(60) Provisional application No. 62/674,228, filed on May 21, 2018.

(51) Int. Cl. H04L 1/00; H04W 74/08; H04W 72/08; H04B 17/327; H04B 17/10

(52) U.S. Cl. CPC H04L 1/0057; H04W 74/085; H04B 17/102; H04W 72/085; H04B 17/327; H04L 1/0071

(57) ABSTRACT

Embodiments of a User Equipment (UE), Next Generation Node-B (gNB) and methods of communication are generally described herein. The gNB may encode multiple candidate code-block groups to be available for a transmission in unlicensed spectrum, wherein one of the candidate code-block groups is to be transmitted based on a listen-before-talk (LBT) process. Each of the candidate code-block groups may be mapped to a different subset of channels in the unlicensed spectrum. The gNB may determine, based on one or more channel measurements, one or more of the channels that are available for the transmission. The gNB may select, as the candidate code-block group to be transmitted, a candidate code-block group for which the subset of the channels that is mapped to the selected candidate code-block group is included in the one or more channels that are available for the transmission.

### PRIORITY CLAIM

This application claims priority under 35 USC 119(e) to U.S. Provisional Patent Application Ser. No. 62/674,228, filed May 21, 2018 [reference number AB1904-Z (1884.725PRV)], which is incorporated herein by reference in its entirety.

### TECHNICAL FIELD

Embodiments pertain to wireless networks. Some embodiments relate to cellular communication networks including 3GPP (Third Generation Partnership Project) networks, 3GPP LTE (Long Term Evolution) networks, 3GPP LTE-A (LTE Advanced) networks, New Radio (NR) networks, and 5G networks, although the scope of the embodiments is not limited in this respect. Some embodiments relate to adaptation of bandwidth and/or duration of transmissions, including adaptation based on a listen-before-talk (LBT) process.

### BACKGROUND

Efficient use of the resources of a wireless network is important to provide bandwidth and acceptable response times to the users of the wireless network. However, often there are many devices trying to share the same resources and some devices may be limited by the communication protocol they use or by their hardware bandwidth. Moreover, wireless devices may need to operate with both newer protocols and with legacy device protocols.

### BRIEF DESCRIPTION OF THE DRAWINGS

FIG. 1A is a functional diagram of an example network in accordance with some embodiments;

FIG. 1B is a functional diagram of another example network in accordance with some embodiments;

FIG. 2 illustrates a block diagram of an example machine in accordance with some embodiments;

FIG. 3 illustrates a user device in accordance with some aspects;

FIG. 4 illustrates a base station in accordance with some aspects;

FIG. 5 illustrates an exemplary communication circuitry according to some aspects;

FIG. 6 illustrates an example of a radio frame structure in accordance with some embodiments;

FIG. 7A and FIG. 7B illustrate example frequency resources in accordance with some embodiments;

FIG. 8 illustrates the operation of a method of communication in accordance with some embodiments;

FIG. 9 illustrates the operation of another method of communication in accordance with some embodiments;

FIG. 10 illustrates example elements in the frequency domain and example elements in the time domain in accordance with some embodiments;

FIG. 11 illustrates example elements in the frequency domain and example elements in the time domain in accordance with some embodiments;

FIG. 12 illustrates example elements in the frequency domain and example elements in the time domain in accordance with some embodiments;

FIG. 13 illustrates example elements in the frequency domain and example elements in the time domain in accordance with some embodiments; and

FIG. 14 illustrates example elements in the frequency domain in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

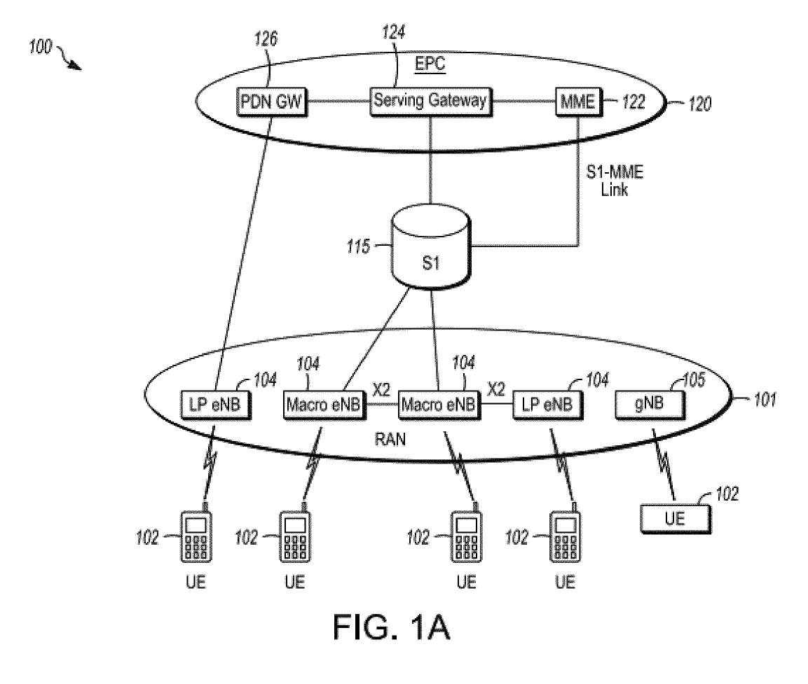

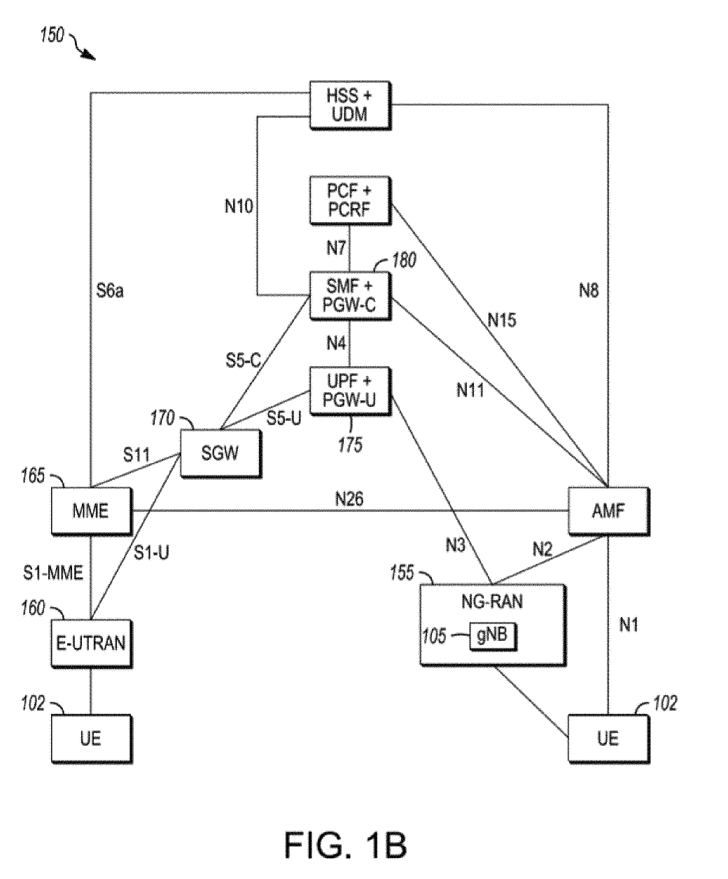

FIG. 1A is a functional diagram of an example network in accordance with some embodiments. FIG. 1B is a functional diagram of another example network in accordance with some embodiments. In references herein, “FIG. 1” may include FIG. 1A and FIG. 1B. In some embodiments, the network 100 may be a Third Generation Partnership Project (3GPP) network. In some embodiments, the network 150 may be a 3GPP network. In a non-limiting example, the network 150 may be a new radio (NR) network. It should be noted that embodiments are not limited to usage of 3GPP networks, however, as other networks may be used in some embodiments. As an example, a Fifth Generation (5G) network may be used in some cases. As another example, a New Radio (NR) network may be used in some cases. As another example, a wireless local area network (WLAN) may be used in some cases. Embodiments are not limited to these example networks, however, as other networks may be used in some embodiments. In some embodiments, a network may include one or more components shown in FIG. 1A. Some embodiments may not necessarily include all components shown in FIG. 1A, and some embodiments may include additional components not shown in FIG. 1A. In some embodiments, a network may include one or more components shown in FIG. 1B. Some embodiments may not necessarily include all components shown in FIG. 1B, and some embodiments may include additional components not shown in FIG. 1B. In some embodiments, a network may include one or more components shown in FIG. 1A and one or more components shown in FIG. 1B. In some embodiments, a network may include one or more components shown in FIG. 1A, one or more components shown in FIG. 1B and one or more additional components.

The network 100 may comprise a radio access network (RAN) 101 and the core network 120 (e.g., shown as an evolved packet core (EPC)) coupled together through an S1 interface 115. For convenience and brevity sake, only a portion of the core network 120, as well as the RAN 101, is shown. In a non-limiting example, the RAN 101 may be an evolved universal terrestrial radio access network (E-UTRAN). In another non-limiting example, the RAN 101 may include one or more components of a New Radio (NR) network. In another non-limiting example, the RAN 101 may include one or more components of an E-UTRAN and one or more components of another network (including but not limited to an NR network).

The core network 120 may include a mobility management entity (MME) 122, a serving gateway (serving GW) 124, and packet data network gateway (PDN GW) 126. In some embodiments, the network 100 may include (and/or support) one or more Evolved Node-B's (eNBs) 104 (which may operate as base stations) for communicating with User Equipment (UE) 102. The eNBs 104 may include macro eNBs and low power (LP) eNBs, in some embodiments.

In some embodiments, the network 100 may include (and/or support) one or more Next Generation Node-B's (gNBs) 105. In some embodiments, one or more eNBs 104 may be configured to operate as gNBs 105. Embodiments are not limited to the number of eNBs 104 shown in FIG. 1A or to the number of gNBs 105 shown in FIG. 1A. In some embodiments, the network 100 may not necessarily include eNBs 104. Embodiments are also not limited to the connectivity of components shown in FIG. 1A.

It should be noted that references herein to an eNB 104 or to a gNB 105 are not limiting. In some embodiments, one or more operations, methods and/or techniques (such as those described herein) may be practiced by a base station component (and/or other component), including but not limited to a gNB 105, an eNB 104, a serving cell, a transmit receive point (TRP) and/or other. In some embodiments, the base station component may be configured to operate in accordance with a New Radio (NR) protocol and/or NR standard, although the scope of embodiments is not limited in this respect. In some embodiments, the base station component may be configured to operate in accordance with a Fifth Generation (5G) protocol and/or 5G standard, although the scope of embodiments is not limited in this respect.

In some embodiments, one or more of the UEs 102, gNBs 105, and/or eNBs 104 may be configured to operate in accordance with an NR protocol and/or NR techniques. References to a UE 102, eNB 104, and/or gNB 105 as part of descriptions herein are not limiting. For instance, descriptions of one or more operations, techniques and/or methods practiced by a gNB 105 are not limiting. In some embodiments, one or more of those operations, techniques and/or methods may be practiced by an eNB 104 and/or other base station component.

In some embodiments, the UE 102 may transmit signals (data, control and/or other) to the gNB 105, and may receive signals (data, control and/or other) from the gNB 105. In some embodiments, the UE 102 may transmit signals (data, control and/or other) to the eNB 104, and may receive signals (data, control and/or other) from the eNB 104. These embodiments will be described in more detail below.

The MME 122 is similar in function to the control plane of legacy Serving GPRS Support Nodes (SGSN). The MME 122 manages mobility aspects in access such as gateway selection and tracking area list management. The serving GW 124 terminates the interface toward the RAN 101, and routes data packets between the RAN 101 and the core network 120. In addition, it may be a local mobility anchor point for inter-eNB handovers and also may provide an anchor for inter-3GPP mobility. Other responsibilities may include lawful intercept, charging, and some policy enforcement. The serving GW 124 and the MME 122 may be implemented in one physical node or separate physical nodes. The PDN GW 126 terminates an SGi interface toward the packet data network (PDN). The PDN GW 126 routes data packets between the EPC 120 and the external PDN, and may be a key node for policy enforcement and charging data collection. It may also provide an anchor point for mobility with non-LTE accesses. The external PDN can be any kind of IP network, as well as an IP Multimedia Subsystem (IMS) domain. The PDN GW 126 and the serving GW 124 may be implemented in one physical node or separated physical nodes.

In some embodiments, the eNBs 104 (macro and micro) terminate the air interface protocol and may be the first point of contact for a UE 102. In some embodiments, an eNB 104 may fulfill various logical functions for the network 100, including but not limited to RNC (radio network controller functions) such as radio bearer management, uplink and downlink dynamic radio resource management and data packet scheduling, and mobility management.

In some embodiments, UEs 102 may be configured to communicate Orthogonal Frequency Division Multiplexing (OFDM) communication signals with an eNB 104 and/or gNB 105 over a multicarrier communication channel in accordance with an Orthogonal Frequency Division Multiple Access (OFDMA) communication technique. In some embodiments, eNBs 104 and/or gNBs 105 may be configured to communicate OFDM communication signals with a UE 102 over a multicarrier communication channel in accordance with an OFDMA communication technique. The OFDM signals may comprise a plurality of orthogonal subcarriers.

The S1 interface 115 is the interface that separates the RAN 101 and the EPC 120. It may be split into two parts: the S1-U, which carries traffic data between the eNBs 104 and the serving GW 124, and the S1-MME, which is a signaling interface between the eNBs 104 and the MME 122. The X2 interface is the interface between eNBs 104. The X2 interface comprises two parts, the X2-C and X2-U. The X2-C is the control plane interface between the eNBs 104, while the X2-U is the user plane interface between the eNBs 104.

In some embodiments, similar functionality and/or connectivity described for the eNB 104 may be used for the gNB 105, although the scope of embodiments is not limited in this respect. In a non-limiting example, the S1 interface 115 (and/or similar interface) may be split into two parts: the S1-U, which carries traffic data between the gNBs 105 and the serving GW 124, and the S1-MME, which is a signaling interface between the gNBs 104 and the MME 122. The X2 interface (and/or similar interface) may enable communication between eNBs 104, communication between gNBs 105 and/or communication between an eNB 104 and a gNB 105.

With cellular networks, LP cells are typically used to extend coverage to indoor areas where outdoor signals do not reach well, or to add network capacity in areas with very dense phone usage, such as train stations. As used herein, the term low power (LP) eNB refers to any suitable relatively low power eNB for implementing a narrower cell (narrower than a macro cell) such as a femtocell, a picocell, or a micro cell. Femtocell eNBs are typically provided by a mobile network operator to its residential or enterprise customers. A femtocell is typically the size of a residential gateway or smaller and generally connects to the user's broadband line. Once plugged in, the femtocell connects to the mobile operator's mobile network and provides extra coverage in a range of typically 30 to 50 meters for residential femtocells. Thus, a LP eNB might be a femtocell eNB since it is coupled through the PDN GW 126. Similarly, a picocell is a wireless communication system typically covering a small area, such as in-building (offices, shopping malls, train stations, etc.), or more recently in-aircraft. A picocell eNB can generally connect through the X2 link to another eNB such as a macro eNB through its base station controller (BSC) functionality. Thus, LP eNB may be implemented with a picocell eNB since it is coupled to a macro eNB via an X2 interface. Picocell eNBs or other LP eNBs may incorporate some or all functionality of a macro eNB. In some cases, this may be referred to as an access point base station or enterprise femtocell. In some embodiments, various types of gNBs 105 may be used, including but not limited to one or more of the eNB types described above.

In some embodiments, the network 150 may include one or more components configured to operate in accordance with one or more 3GPP standards, including but not limited to an NR standard. The network 150 shown in FIG. 1B may include a next generation RAN (NG-RAN) 155, which may include one or more gNBs 105. In some embodiments, the network 150 may include the E-UTRAN 160, which may include one or more eNBs. The E-UTRAN 160 may be similar to the RAN 101 described herein, although the scope of embodiments is not limited in this respect.

In some embodiments, the network 150 may include the MME 165. The MME 165 may be similar to the MME 122 described herein, although the scope of embodiments is not limited in this respect. The MME 165 may perform one or more operations or functionality similar to those described herein regarding the MME 122, although the scope of embodiments is not limited in this respect.

In some embodiments, the network 150 may include the SGW 170. The SGW 170 may be similar to the SGW 124 described herein, although the scope of embodiments is not limited in this respect. The SGW 170 may perform one or more operations or functionality similar to those described herein regarding the SGW 124, although the scope of embodiments is not limited in this respect.

In some embodiments, the network 150 may include component(s) and/or module(s) for functionality for a user plane function (UPF) and user plane functionality for PGW (PGW-U), as indicated by 175. In some embodiments, the network 150 may include component(s) and/or module(s) for functionality for a session management function (SMF) and control plane functionality for PGW (PGW-C), as indicated by 180. In some embodiments, the component(s) and/or module(s) indicated by 175 and/or 180 may be similar to the PGW 126 described herein, although the scope of embodiments is not limited in this respect. The component(s) and/or module(s) indicated by 175 and/or 180 may perform one or more operations or functionality similar to those described herein regarding the PGW 126, although the scope of embodiments is not limited in this respect. One or both of the components 170, 172 may perform at least a portion of the functionality described herein for the PGW 126, although the scope of embodiments is not limited in this respect.

Embodiments are not limited to the number or type of components shown in FIG. 1B. Embodiments are also not limited to the connectivity of components shown in FIG. 1B.

In some embodiments, a downlink resource grid may be used for downlink transmissions from an eNB 104 to a UE 102, while uplink transmission from the UE 102 to the eNB 104 may utilize similar techniques. In some embodiments, a downlink resource grid may be used for downlink transmissions from a gNB 105 to a UE 102, while uplink transmission from the UE 102 to the gNB 105 may utilize similar techniques. The grid may be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid correspond to one OFDM symbol and one OFDM subcarrier, respectively. The duration of the resource grid in the time domain corresponds to one slot in a radio frame. The smallest time-frequency unit in a resource grid is denoted as a resource element (RE). There are several different physical downlink channels that are conveyed using such resource blocks. With particular relevance to this disclosure, two of these physical downlink channels are the physical downlink shared channel and the physical down link control channel.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

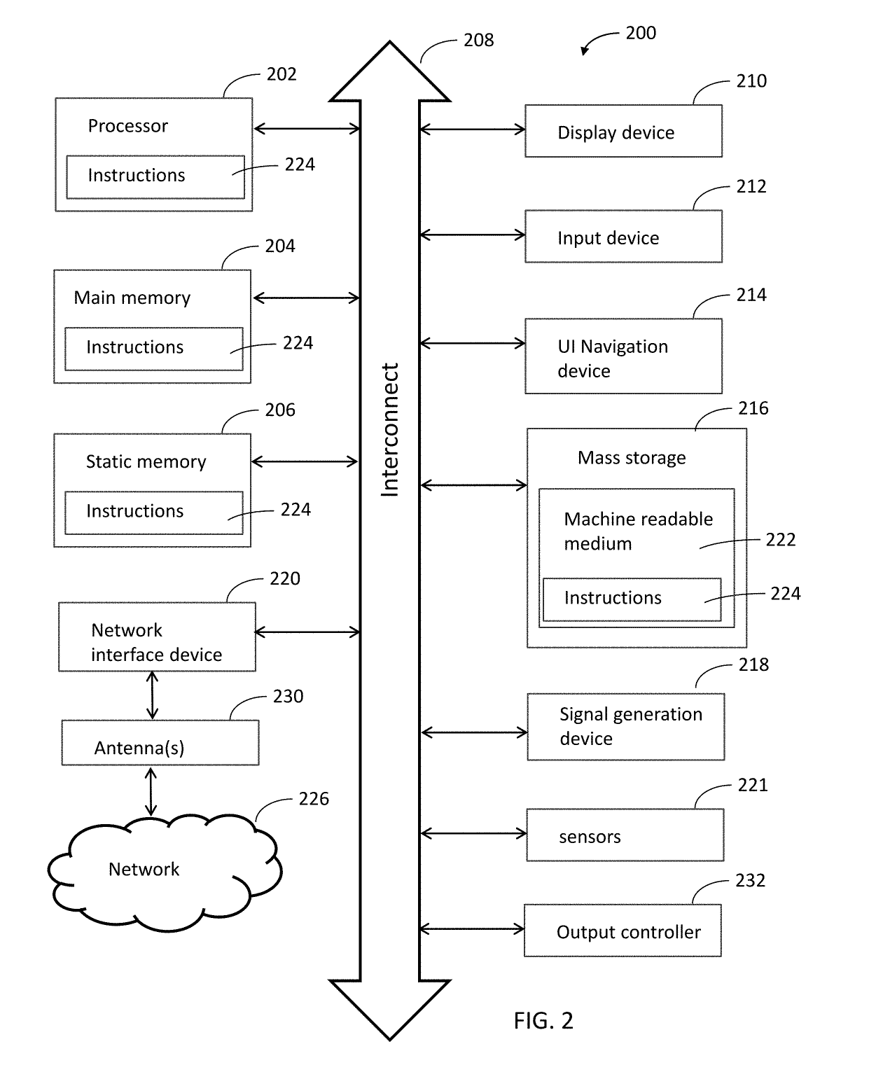

FIG. 2 illustrates a block diagram of an example machine in accordance with some embodiments. The machine 200 is an example machine upon which any one or more of the techniques and/or methodologies discussed herein may be performed. In alternative embodiments, the machine 200 may operate as a standalone device or may be connected (e.g., networked) to other machines. In a networked deployment, the machine 200 may operate in the capacity of a server machine, a client machine, or both in server-client network environments. In an example, the machine 200 may act as a peer machine in peer-to-peer (P2P) (or other distributed) network environment. The machine 200 may be a UE 102, eNB 104, gNB 105, TX node, RX node, access point (AP), station (STA), user, device, mobile device, base station, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The machine (e.g., computer system) 200 may include a hardware processor 202 (e.g., a central processing unit (CPU), a graphics processing unit (GPU), a hardware processor core, or any combination thereof), a main memory 204 and a static memory 206, some or all of which may communicate with each other via an interlink (e.g., bus) 208. The machine 200 may further include a display unit 210, an alphanumeric input device 212 (e.g., a keyboard), and a user interface (UI) navigation device 214 (e.g., a mouse). In an example, the display unit 210, input device 212 and UI navigation device 214 may be a touch screen display. The machine 200 may additionally include a storage device (e.g., drive unit) 216, a signal generation device 218 (e.g., a speaker), a network interface device 220, and one or more sensors 221, such as a global positioning system (GPS) sensor, compass, accelerometer, or other sensor. The machine 200 may include an output controller 228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a machine readable medium 222 on which is stored one or more sets of data structures or instructions 224 (e.g., software) embodying or utilized by any one or more of the techniques or functions described herein. The instructions 224 may also reside, completely or at least partially, within the main memory 204, within static memory 206, or within the hardware processor 202 during execution thereof by the machine 200. In an example, one or any combination of the hardware processor 202, the main memory 204, the static memory 206, or the storage device 216 may constitute machine readable media. In some embodiments, the machine readable medium may be or may include a non-transitory computer-readable storage medium. In some embodiments, the machine readable medium may be or may include a computer-readable storage medium.

While the machine readable medium 222 is illustrated as a single medium, the term “machine readable medium” may include a single medium or multiple media (e.g., a centralized or distributed database, and/or associated caches and servers) configured to store the one or more instructions 224. The term “machine readable medium” may include any medium that is capable of storing, encoding, or carrying instructions for execution by the machine 200 and that cause the machine 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 224 may further be transmitted or received over a communications network 226 using a transmission medium via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 220 may include one or more physical jacks (e.g., Ethernet, coaxial, or phone jacks) or one or more antennas to connect to the communications network 226. In an example, the network interface device 220 may include a plurality of antennas to wirelessly communicate using at least one of single-input multiple-output (SIMO), multiple-input multiple-output (MIMO), or multiple-input single-output (MISO) techniques. In some examples, the network interface device 220 may wirelessly communicate using Multiple User MIMO techniques. The term “transmission medium” shall be taken to include any intangible medium that is capable of storing, encoding or carrying instructions for execution by the machine 200, and includes digital or analog communications signals or other intangible medium to facilitate communication of such software.

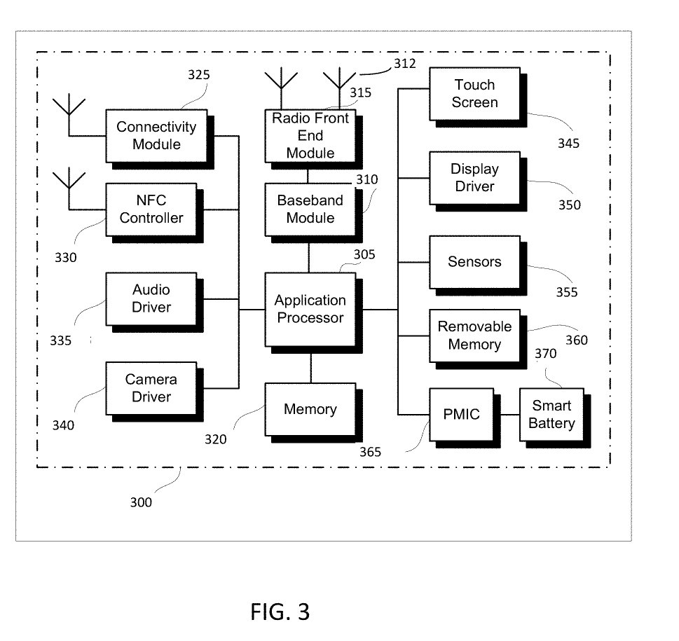

FIG. 3 illustrates a user device in accordance with some aspects. In some embodiments, the user device 300 may be a mobile device. In some embodiments, the user device 300 may be or may be configured to operate as a User Equipment (UE). In some embodiments, the user device 300 may be arranged to operate in accordance with a new radio (NR) protocol. In some embodiments, the user device 300 may be arranged to operate in accordance with a Third Generation Partnership Protocol (3GPP) protocol. The user device 300 may be suitable for use as a UE 102 as depicted in FIG. 1, in some embodiments. It should be noted that in some embodiments, a UE, an apparatus of a UE, a user device or an apparatus of a user device may include one or more of the components shown in one or more of FIGS. 2, 3, and 5. In some embodiments, such a UE, user device and/or apparatus may include one or more additional components.

In some aspects, the user device 300 may include an application processor 305, baseband processor 310 (also referred to as a baseband module), radio front end module (RFEM) 315, memory 320, connectivity module 325, near field communication (NFC) controller 330, audio driver 335, camera driver 340, touch screen 345, display driver 350, sensors 355, removable memory 360, power management integrated circuit (PMIC) 365 and smart battery 370. In some aspects, the user device 300 may be a User Equipment (UE).

In some aspects, application processor 305 may include, for example, one or more CPU cores and one or more of cache memory, low drop-out voltage regulators (LDOs), interrupt controllers, serial interfaces such as serial peripheral interface (SPI), inter-integrated circuit (I²C) or universal programmable serial interface module, real time clock (RTC), timer-counters including interval and watchdog timers, general purpose input-output (IO), memory card controllers such as secure digital/multi-media card (SD/MMC) or similar, universal serial bus (USB) interfaces, mobile industry processor interface (MIPI) interfaces and Joint Test Access Group (JTAG) test access ports.

In some aspects, baseband module 310 may be implemented, for example, as a solder-down substrate including one or more integrated circuits, a single packaged integrated circuit soldered to a main circuit board, and/or a multi-chip module containing two or more integrated circuits.

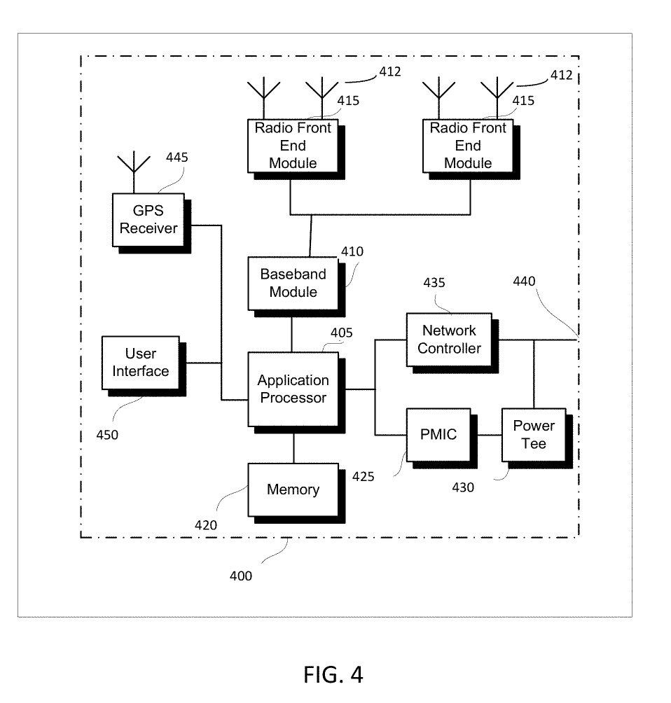

FIG. 4 illustrates a base station in accordance with some aspects. In some embodiments, the base station 400 may be or may be configured to operate as an Evolved Node-B (eNB). In some embodiments, the base station 400 may be or may be configured to operate as a Next Generation Node-B (gNB). In some embodiments, the base station 400 may be arranged to operate in accordance with a new radio (NR) protocol. In some embodiments, the base station 400 may be arranged to operate in accordance with a Third Generation Partnership Protocol (3GPP) protocol. It should be noted that in some embodiments, the base station 400 may be a stationary non-mobile device. The base station 400 may be suitable for use as an eNB 104 as depicted in FIG. 1, in some embodiments. The base station 400 may be suitable for use as a gNB 105 as depicted in FIG. 1, in some embodiments. It should be noted that in some embodiments, an eNB, an apparatus of an eNB, a gNB, an apparatus of a gNB, a base station and/or an apparatus of a base station may include one or more of the components shown in one or more of FIGS. 2, 4, and 5. In some embodiments, such an eNB, gNB, base station and/or apparatus may include one or more additional components.

FIG. 4 illustrates a base station or infrastructure equipment radio head 400 in accordance with some aspects. The base station 400 may include one or more of application processor 405, baseband modules 410, one or more radio front end modules 415, memory 420, power management circuitry 425, power tee circuitry 430, network controller 435, network interface connector 440, satellite navigation receiver module 445, and user interface 450. In some aspects, the base station 400 may be an Evolved Node-B (eNB), which may be arranged to operate in accordance with a 3GPP protocol, new radio (NR) protocol and/or Fifth Generation (5G) protocol. In some aspects, the base station 400 may be a Next Generation Node-B (gNB), which may be arranged to operate in accordance with a 3GPP protocol, new radio (NR) protocol and/or Fifth Generation (5G) protocol.

In some aspects, application processor 405 may include one or more CPU cores and one or more of cache memory, low drop-out voltage regulators (LDOs), interrupt controllers, serial interfaces such as SPI, I²C or universal programmable serial interface module, real time clock (RTC), timer-counters including interval and watchdog timers, general purpose IO, memory card controllers such as SD/MMC or similar, USB interfaces, MIPI interfaces and Joint Test Access Group (JTAG) test access ports.

In some aspects, baseband processor 410 may be implemented, for example, as a solder-down substrate including one or more integrated circuits, a single packaged integrated circuit soldered to a main circuit board or a multi-chip module containing two or more integrated circuits.

In some aspects, memory 420 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magneto-resistive random access memory (MRAM) and/or a three-dimensional cross-point memory. Memory 420 may be implemented as one or more of solder down packaged integrated circuits, socketed memory modules and plug-in memory cards.

In some aspects, power management integrated circuitry 425 may include one or more of voltage regulators, surge protectors, power alarm detection circuitry and one or more backup power sources such as a battery or capacitor. Power alarm detection circuitry may detect one or more of brown out (under-voltage) and surge (over-voltage) conditions.

In some aspects, power tee circuitry 430 may provide for electrical power drawn from a network cable to provide both power supply and data connectivity to the base station 400 using a single cable. In some aspects, network controller 435 may provide connectivity to a network using a standard network interface protocol such as Ethernet. Network connectivity may be provided using a physical connection which is one of electrical (commonly referred to as copper interconnect), optical or wireless.

In some aspects, satellite navigation receiver module 445 may include circuitry to receive and decode signals transmitted by one or more navigation satellite constellations such as the global positioning system (GPS), Globalnaya Navigatsionnaya Sputnikovaya Sistema (GLONASS), Galileo and/or BeiDou. The receiver 445 may provide data to application processor 405 which may include one or more of position data or time data. Application processor 405 may use time data to synchronize operations with other radio base stations. In some aspects, user interface 450 may include one or more of physical or virtual buttons, such as a reset button, one or more indicators such as light emitting diodes (LEDs) and a display screen.

FIG. 5 illustrates an exemplary communication circuitry according to some aspects. Circuitry 500 is alternatively grouped according to functions. Components as shown in 500 are shown here for illustrative purposes and may include other components not shown here in FIG. 5. In some aspects, the communication circuitry 500 may be used for millimeter wave communication, although aspects are not limited to millimeter wave communication. Communication at any suitable frequency may be performed by the communication circuitry 500 in some aspects.

It should be noted that a device, such as a UE 102, eNB 104, gNB 105, the TX node, the RX node, the user device 300, the base station 400, the machine 200 and/or other device may include one or more components of the communication circuitry 500, in some aspects.

The communication circuitry 500 may include protocol processing circuitry 505, which may implement one or more of medium access control (MAC), radio link control (RLC), packet data convergence protocol (PDCP), radio resource control (RRC) and non-access stratum (NAS) functions. Protocol processing circuitry 505 may include one or more processing cores (not shown) to execute instructions and one or more memory structures (not shown) to store program and data information.

The communication circuitry 500 may further include digital baseband circuitry 510, which may implement physical layer (PHY) functions including one or more of hybrid automatic repeat request (HARD) functions, scrambling and/or descrambling, coding and/or decoding, layer mapping and/or de-mapping, modulation symbol mapping, received symbol and/or bit metric determination, multi-antenna port pre-coding and/or decoding which may include one or more of space-time, space-frequency or spatial coding, reference signal generation and/or detection, preamble sequence generation and/or decoding, synchronization sequence generation and/or detection, control channel signal blind decoding, and other related functions.

The communication circuitry 500 may further include transmit circuitry 515, receive circuitry 520 and/or antenna array circuitry 530. The communication circuitry 500 may further include radio frequency (RF) circuitry 525. In an aspect of the disclosure, RF circuitry 525 may include multiple parallel RF chains for one or more of transmit or receive functions, each connected to one or more antennas of the antenna array 530.

In an aspect of the disclosure, protocol processing circuitry 505 may include one or more instances of control circuitry (not shown) to provide control functions for one or more of digital baseband circuitry 510, transmit circuitry 515, receive circuitry 520, and/or radio frequency circuitry 525.

In some embodiments, processing circuitry may perform one or more operations described herein and/or other operation(s). In a non-limiting example, the processing circuitry may include one or more components such as the processor 202, application processor 305, baseband module 310, application processor 405, baseband module 410, protocol processing circuitry 505, digital baseband circuitry 510, similar component(s) and/or other component(s).

In some embodiments, a transceiver may transmit one or more elements (including but not limited to those described herein) and/or receive one or more elements (including but not limited to those described herein). In a non-limiting example, the transceiver may include one or more components such as the radio front end module 315, radio front end module 415, transmit circuitry 515, receive circuitry 520, radio frequency circuitry 525, similar component(s) and/or other component(s).

One or more antennas (such as 230, 312, 412, 530 and/or others) may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, one or more of the antennas (such as 230, 312, 412, 530 and/or others) may be effectively separated to take advantage of spatial diversity and the different channel characteristics that may result.

In some embodiments, the UE 102, eNB 104, gNB 105, TX node, RX node, user device 300, base station 400, machine 200 and/or other device described herein may be a mobile device and/or portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly. In some embodiments, the UE 102, eNB 104, gNB 105, TX node, RX node, user device 300, base station 400, machine 200 and/or other device described herein may be configured to operate in accordance with 3GPP standards, although the scope of the embodiments is not limited in this respect. In some embodiments, the UE 102, eNB 104, gNB 105, TX node, RX node, user device 300, base station 400, machine 200 and/or other device described herein may be configured to operate in accordance with new radio (NR) standards, although the scope of the embodiments is not limited in this respect. In some embodiments, the UE 102, eNB 104, gNB 105, TX node, RX node, user device 300, base station 400, machine 200 and/or other device described herein may be configured to operate according to other protocols or standards, including IEEE 802.11 or other IEEE standards. In some embodiments, the UE 102, eNB 104, gNB 105, TX node, RX node, user device 300, base station 400, machine 200 and/or other device described herein may include one or more of a keyboard, a display, a non-volatile memory port, multiple antennas, a graphics processor, an application processor, speakers, and other mobile device elements. The display may be an LCD screen including a touch screen.

Although the UE 102, eNB 104, gNB 105, TX node, RX node, user device 300, base station 400, machine 200 and/or other device described herein may each be illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

It should be noted that in some embodiments, an apparatus of the UE 102, eNB 104, gNB 105, transmit (TX) node, receive (RX) node, machine 200, user device 300 and/or base station 400 may include various components shown in FIGS. 2-5. Accordingly, techniques and operations described herein that refer to the UE 102 may be applicable to an apparatus of a UE. In addition, techniques and operations described herein that refer to the eNB 104 may be applicable to an apparatus of an eNB. In addition, techniques and operations described herein that refer to the gNB 105 may be applicable to an apparatus of a gNB. Accordingly, techniques and operations described herein that refer to the TX node may be applicable to an apparatus of a TX node. Accordingly, techniques and operations described herein that refer to the RX node may be applicable to an apparatus of a RX node.

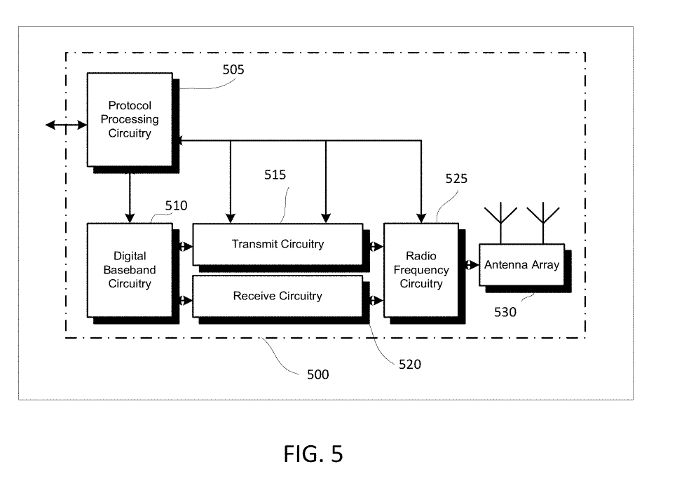

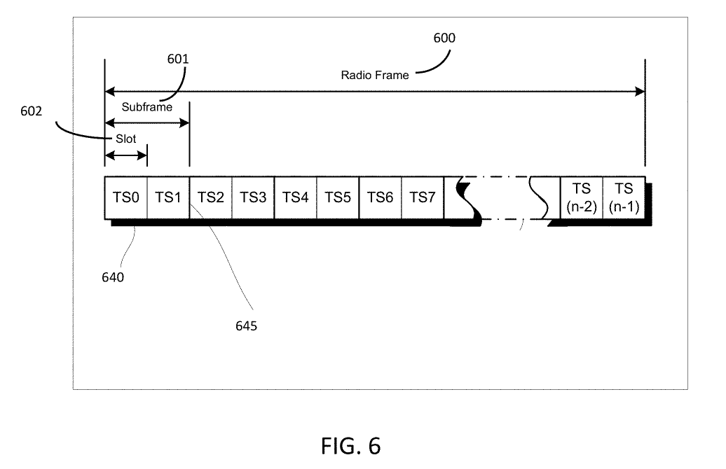

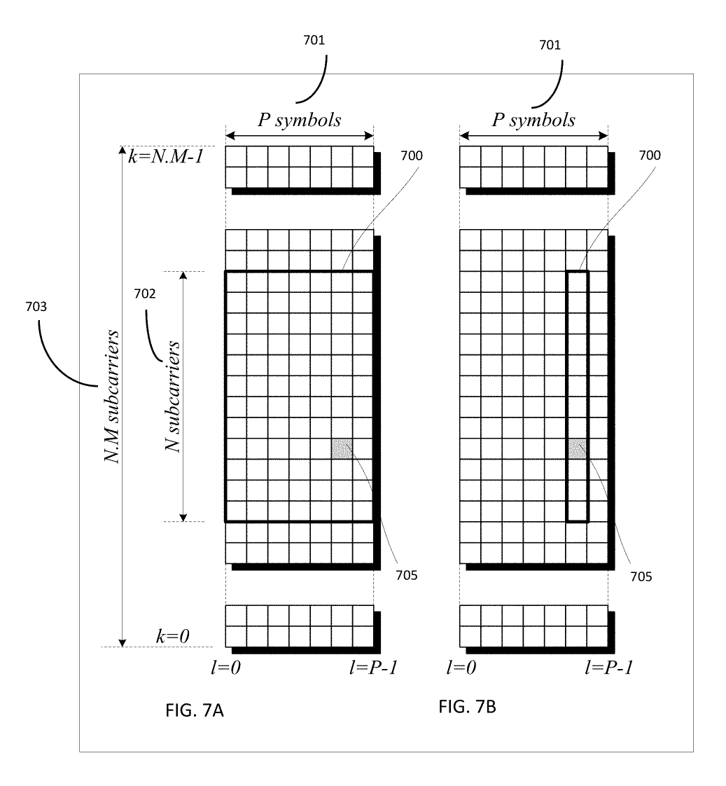

FIG. 6 illustrates an example of a radio frame structure in accordance with some embodiments. FIGS. 7A and 7B illustrate example frequency resources in accordance with some embodiments. In references herein, “FIG. 7” may include FIG. 7A and FIG. 7B. It should be noted that the examples shown in FIGS. 6-7 may illustrate some or all of the concepts and techniques described herein in some cases, but embodiments are not limited by the examples. For instance, embodiments are not limited by the name, number, type, size, ordering, arrangement and/or other aspects of the time resources, symbol periods, frequency resources, PRBs and other elements as shown in FIGS. 6-7. Although some of the elements shown in the examples of FIGS. 6-7 may be included in a 3GPP LTE standard, 5G standard, NR standard and/or other standard, embodiments are not limited to usage of such elements that are included in standards.

An example of a radio frame structure that may be used in some aspects is shown in FIG. 6. In this example, radio frame 600 has a duration of 10 ms. Radio frame 600 is divided into slots 602 each of duration 0.5 ms, and numbered from 0 to 19. Additionally, each pair of adjacent slots 602 numbered 2i and 2i+1, where i is an integer, is referred to as a subframe 601.

In some aspects using the radio frame format of FIG. 6, each subframe 601 may include a combination of one or more of downlink control information, downlink data information, uplink control information and uplink data information. The combination of information types and direction may be selected independently for each subframe 602.

Referring to FIGS. 7A and 7B, in some aspects, a sub-component of a transmitted signal consisting of one subcarrier in the frequency domain and one symbol interval in the time domain may be termed a resource element. Resource elements may be depicted in a grid form as shown in FIG. 7A and FIG. 7B.

In some aspects, illustrated in FIG. 7A, resource elements may be grouped into rectangular resource blocks 700 consisting of 12 subcarriers in the frequency domain and the P symbols in the time domain, where P may correspond to the number of symbols contained in one slot, and may be 6, 7, or any other suitable number of symbols.

In some alternative aspects, illustrated in FIG. 7B, resource elements may be grouped into resource blocks 700 consisting of 12 subcarriers (as indicated by 702) in the frequency domain and one symbol in the time domain. In the depictions of FIG. 7A and FIG. 7B, each resource element 705 may be indexed as (k, l) where k is the index number of subcarrier, in the range 0 to N.M−1 (as indicated by 703), where N is the number of subcarriers in a resource block, and M is the number of resource blocks spanning a component carrier in the frequency domain.

In accordance with some embodiments, a transmit (TX) node may encode multiple candidate code-block groups to be available for a transmission in unlicensed spectrum, wherein one of the candidate code-block groups is to be transmitted based on a listen-before-talk (LBT) process. The unlicensed spectrum may comprise multiple channels. Each of the candidate code-block groups may be mapped to a different subset of the channels. At least some of the subsets of the channels may at least partly overlap. The TX node may, as part of the LBT process: determine one or more channel measurements of the channels; determine, based on the channel measurements, one or more of the channels that are available for the transmission; and select the candidate code-block group to be transmitted based on a criterion that the subset of the channels that is mapped to the selected candidate code-block group is included in the one or more channels that are available for the transmission. These embodiments are described in more detail below.

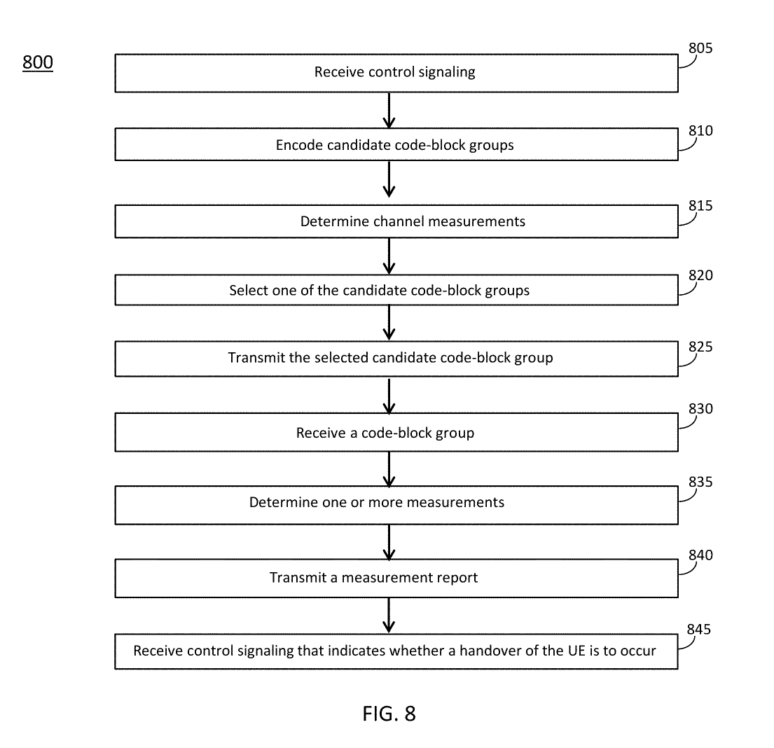

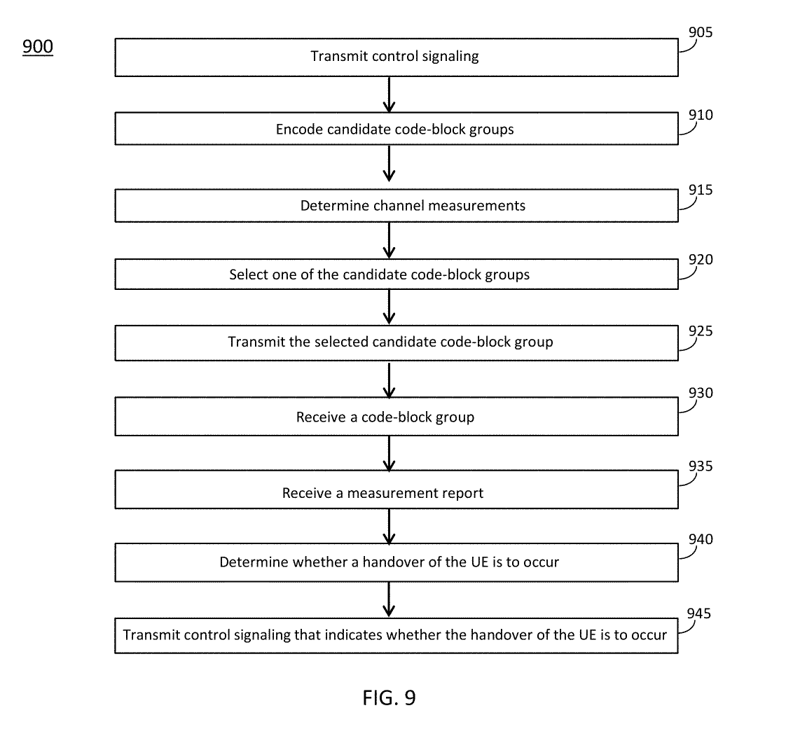

FIG. 8 illustrates the operation of a method of communication in accordance with some embodiments. FIG. 9 illustrates the operation of another method of communication in accordance with some embodiments. It is important to note that embodiments of the methods 800, 900 may include additional or even fewer operations or processes in comparison to what is illustrated in FIGS. 8-9. In addition, embodiments of the methods 800, 900 are not necessarily limited to the chronological order that is shown in FIGS. 8-9. In describing the methods 800, 900, reference may be made to one or more figures, although it is understood that the methods 800, 900 may be practiced with any other suitable systems, interfaces and components.

In some embodiments, a transmit (TX) node (such as a gNB 105 and/or UE 102) may perform one or more operations of the method 800, but embodiments are not limited to performance of the method 800 and/or operations of it by the TX node. In some embodiments, another device and/or component may perform one or more operations of the method 800. In some embodiments, another device and/or component may perform one or more operations that may be similar to one or more operations of the method 800. In some embodiments, another device and/or component may perform one or more operations that may be reciprocal to one or more operations of the method 800. In a non-limiting example, the gNB 105 may perform an operation that may be the same as, similar to, reciprocal to and/or related to an operation of the method 800, in some embodiments. In another non-limiting example, the UE 102 may perform an operation that may be the same as, similar to, reciprocal to and/or related to an operation of the method 800, in some embodiments. In another non-limiting example, a receive (RX) node (which may be a gNB 105, UE 102 and/or other device) may perform an operation that may be the same as, similar to, reciprocal to and/or related to an operation of the method 800, in some embodiments.

In addition, embodiments are not limited to performance of any operation described herein by the TX node, RX node, gNB 105, UE 102 or other device. In some embodiments, the TX node, RX node, gNB 105, UE 102 and/or other device may perform one or more operations that may be the same as, similar to, and/or reciprocal to one or more operations of any of the methods described herein (including but not limited to 800 and 900).

In some embodiments, a TX node, a gNB 105 and/or UE 102 may perform one or more operations of the method 900, but embodiments are not limited to performance of the method 900 and/or operations of it by the TX node, gNB 105 and/or UE 102. In some embodiments, another device and/or component may perform one or more operations of the method 900. In some embodiments, another device and/or component may perform one or more operations that may be similar to one or more operations of the method 900. In some embodiments, another device and/or component may perform one or more operations that may be reciprocal to one or more operations of the method 900.

Embodiments are not limited to descriptions herein of performance of an operation by one of: the TX node, gNB 105 or UE 102. In some embodiments, such an operation may be performed by any of: the TX node, gNB 105, UE 102 and/or other device.

It should be noted that one or more operations of one of the methods 800, 900 may be the same as, similar to and/or reciprocal to one or more operations of the other method. For instance, an operation of the method 800 may be the same as, similar to and/or reciprocal to an operation of the method 900, in some embodiments. In a non-limiting example, an operation of the method 800 may include reception of an element (such as a frame, block, message and/or other) by the UE 102, and an operation of the method 900 may include transmission of a same element (and/or similar element) by the gNB 105. In some cases, descriptions of operations and techniques described as part of one of the methods 800, 900 may be relevant to the other method.

Discussion of various operations, techniques and/or concepts regarding one of the methods 800, 900 and/or other method may be applicable to one of the other methods, although the scope of embodiments is not limited in this respect. Such operations, techniques and/or concepts may be related to transport blocks (TBs), code-block groups, measurements, channel measurements, LBT and/or other.

The methods 800, 900 and other methods described herein may refer to eNBs 104, gNBs 105 and/or UEs 102 operating in accordance with 3GPP standards, 5G standards, NR standards and/or other standards. However, embodiments are not limited to performance of those methods by those components, and may also be performed by other devices, such as a Wi-Fi access point (AP) or user station (STA). In addition, the methods 800, 900 and other methods described herein may be practiced by wireless devices configured to operate in other suitable types of wireless communication systems, including systems configured to operate according to various IEEE standards such as IEEE 802.11. The methods 800, 900 may also be applicable to an apparatus of a UE 102, an apparatus of an eNB 104, an apparatus of a gNB 105 and/or an apparatus of another device described above.

It should also be noted that embodiments are not limited by references herein (such as in descriptions of the methods 800, 900 and/or other descriptions herein) to transmission, reception and/or exchanging of elements such as frames, messages, requests, indicators, signals or other elements. In some embodiments, such an element may be generated, encoded or otherwise processed by processing circuitry (such as by a baseband processor included in the processing circuitry) for transmission. The transmission may be performed by a transceiver or other component, in some cases. In some embodiments, such an element may be decoded, detected or otherwise processed by the processing circuitry (such as by the baseband processor). The element may be received by a transceiver or other component, in some cases. In some embodiments, the processing circuitry and the transceiver may be included in a same apparatus. The scope of embodiments is not limited in this respect, however, as the transceiver may be separate from the apparatus that comprises the processing circuitry, in some embodiments.

One or more of the elements (such as messages, operations and/or other) described herein may be included in a standard and/or protocol, including but not limited to Third Generation Partnership Project (3GPP), 3GPP Long Term Evolution (LTE), Fourth Generation (4G), Fifth Generation (5G), New Radio (NR) and/or other. Embodiments are not limited to usage of those elements, however. In some embodiments, other elements may be used, including other element(s) in a same standard/protocol, other element(s) in another standard/protocol and/or other. In addition, the scope of embodiments is not limited to usage of elements that are included in standards.

In some embodiments, the UE 102 may be arranged to operate in accordance with an NR protocol. In some embodiments, the gNB 105 may be arranged to operate in accordance with an NR protocol.

In some embodiments, a transmit (TX) node may perform one or more operations of the method 800. In some embodiments, the TX node may be a UE 102. In some embodiments, the TX node may be a gNB 105. In some embodiments, the TX node may be another device.

At operation 805, the TX node, gNB 105 and/or UE 102 may receive control signaling. In some embodiments, radio resource control (RRC) signaling may be used, although the scope of embodiments is not limited in this respect. Other control signaling and/or other types of control signaling may be used in some embodiments. In some embodiments, the control signaling may include information and/or parameter(s) related to one or more of the operations described herein (including but not limited to operations of the method 800 and/or 900).

At operation 810, the TX node, gNB 105 and/or UE 102 may encode candidate code-block groups. Embodiments are not limited by descriptions herein of operations related to code-block groups, as other elements (such as transport blocks, code-blocks and/or other) may be used, in some embodiments. At operation 815, the TX node, gNB 105 and/or UE 102 may determine one or more channel measurements. In some embodiments, the TX node may receive the channel measurements from a receive (RX) node. In some embodiments, the RX node (which may be a gNB 105, UE 102 and/or other device) may determine the channel measurements. In some embodiments, the RX node (which may be a gNB 105, UE 102 and/or other device) may transmit the channel measurements to the TX node.

At operation 820, the TX node, gNB 105 and/or UE 102 may select one of the candidate code-block groups. At operation 825, the TX node, gNB 105 and/or UE 102 may transmit the selected candidate code-block group.

Embodiments are not limited to selection of one candidate code-block group or to transmission of one candidate code-block group. In some embodiments, the TX node, gNB 105 and/or UE 102 may select a subset of the candidate code-block groups. In some embodiments, the TX node, gNB 105 and/or UE 102 may transmit the subset of selected candidate code-block groups. Other operations may be extended to accommodate usage of the subset of candidate code-block groups.

In some embodiments, the TX node, gNB 105 and/or UE 102 may encode multiple candidate code-block groups to be available for a transmission in unlicensed spectrum, wherein one of the candidate code-block groups is to be transmitted based on a listen-before-talk (LBT) process. In some embodiments, the TX node, gNB 105 and/or UE 102 may encode the multiple candidate code-block groups to be available before the LBT process to enable the transmission in accordance with a target latency, although the scope of embodiments is not limited in this respect.

In some embodiments, the unlicensed spectrum may comprise multiple channels, although the scope of embodiments is not limited in this respect. In some embodiments, each of the candidate code-block groups may be mapped to a different subset of the channels, although the scope of embodiments is not limited in this respect. In some embodiments, at least some of the subsets of the channels may at least partly overlap, although the scope of embodiments is not limited in this respect. In some embodiments, at least some of the subsets of the channels may include different numbers of channels, although the scope of embodiments is not limited in this respect.

In some embodiments, the TX node, gNB 105 and/or UE 102 may encode the candidate code-block groups based on information bits. In some embodiments, at least some of the candidate code-block groups may be based on different numbers of information bits, although the scope of embodiments is not limited in this respect. In a non-limiting example, a first candidate code-block group may be mapped to a first channel, and may be encoded based on first information bits. A second candidate code-block group may be mapped to the first channel and to the second channel, and may be encoded based on the first information bits and further based on second information bits. For instance, the second candidate code-block group is mapped to more frequency resources than the first candidate code-block group, so the TX node, gNB 105 and/or UE 102 may encode the second candidate code-block group based on a second number of information bits that is larger than a first number of information bits used to encode the first candidate code-block group.

In a non-limiting example, the unlicensed spectrum may comprise a first channel, a second channel, and a third channel. The TX node, gNB 105 and/or UE 102 may encode: a first code-block group that is mapped to the first channel; a second code-block group that is mapped to the first channel and the second channel; and a third code-block group that is mapped to the first channel, the second channel, and the third channel. For instance, the channels may be of bandwidth 20 MHz (although other sizes may be used), and the first code-block group, second code-block group, and third code-block group may be mapped to a 20 MHz frequency range, a 40 MHz frequency range, and a 60 MHz frequency range, respectively.

In some embodiments, the TX node, gNB 105 and/or UE 102 may perform one or more of the following: determine one or more channel measurements of the channels; determine, based on the channel measurements, one or more of the channels that are available for the transmission; and select the candidate code-block group to be transmitted. In some embodiments, the TX node, gNB 105 and/or UE 102 may select the candidate code-block group to be transmitted based at least partly on one or more of: one or more of the channel measurements; the one or more channels that are available for transmission; and/or other.

In a non-limiting example, the TX node, gNB 105 and/or UE 102 may select the candidate code-block group to be transmitted based on a criterion that the subset of the channels that is mapped to the selected candidate code-block group is included in the one or more channels that are available for the transmission. In some embodiments, if multiple candidate code-block groups meet the criterion, the TX node, gNB 105 and/or UE 102 may perform one of more of: determine a maximum number of channels mapped to the multiple candidate code-block groups that meet the criterion; and select the candidate code-block group as a candidate code-block group that meets the criterion and for which the number of channels mapped to the selected candidate code-block group is equal to the maximum number of channels. For instance, if multiple candidate code-block groups meet the criterion (that is, the corresponding subsets of channels are available for transmission), the TX node, gNB 105 and/or UE 102 may determine which of those candidate code-block groups is mapped to the largest number of channels, and may select that candidate code-block group. If more than one of the candidate code-block groups meets the criteria (that is, the corresponding subsets of channels are available for transmission) and is mapped to the largest number of channels, the UE 102 may select one of those (using any technique, including but not limited to random selection) as the candidate code-block group to be transmitted.

In another non-limiting example, the TX node, gNB 105 and/or UE 102 may select a subset of candidate code-block groups to be transmitted based on a criterion that the subset of the channels that is mapped to the selected subset of candidate code-block group is included in the one or more channels that are available for the transmission.

In some embodiments, the TX node, gNB 105 and/or UE 102 may, for each of the channels, perform one or more of: determine an individual channel measurement of the channel; if the individual channel measurement of the channel is less than a threshold, include the channel in the one or more channels that are available for the transmission; and if the individual channel measurement of the channel is greater than or equal to the threshold, exclude the channel from the one or more channels that are available for the transmission.

In some embodiments, the channel measurements may be based on an average power level, at the TX node, gNB 105 and/or UE 102, of signals detected from other TX nodes, gNBs 105, UEs 102 and/or other devices.

In some embodiments, the channel measurements may include one or more of: one or more sub-band measurements based on signals detected in individual channels; one or more wideband measurements based on signals detected in an aggregate bandwidth that includes the multiple channels; and/or other.

In some embodiments, the channel measurements may be based on one or more of: one or more RSSIs; one or more channel occupancy measurements; a presence of one or more Third Generation Partnership Project (3GPP) devices operating in the unlicensed spectrum; a presence of one or more non-3GPP devices operating in the unlicensed spectrum; and/or other.

In some embodiments, one or more operations (such as determination of the one or more channel measurements of the channels; determination of the channels that are available for the transmission; selection of the candidate code-block group to be transmitted; and/or other) may be performed as part of the LBT process, although the scope of embodiments is not limited in this respect.

In some embodiments, the TX node, gNB 105 and/or UE 102 may encode multiple candidate code-block groups to be available for a transmission in unlicensed spectrum comprising multiple channels and in a slot comprising multiple orthogonal frequency division multiplexing (OFDM) symbols, wherein one of the candidate code-block groups is to be transmitted based on a listen-before-talk (LBT) process. In some embodiments, the multiple candidate code-block groups are to be available before the LBT process to enable the transmission to meet a target latency, although the scope of embodiments is not limited in this respect. In some embodiments, each of the candidate code-block groups may be mapped to a subset of the channels and may be mapped to a subset of the OFDM symbols. In some embodiments, for at least two of the candidate code-block groups: the corresponding subsets of the channels may be different and may at least partly overlap; and/or the corresponding subsets of the OFDM symbols may be different and may at least partly overlap. In some embodiments, the UE 102 may, for each of the channels and for each of the OFDM symbols of the slot, perform one or more of: determine an availability of the channel is available for the transmission during the slot; select one of the candidate code-block groups for the transmission based on the determined availabilities; and/or other. In some embodiments, the UE 102 may select the candidate code-block group for the transmission based on a criterion that the channel is determined to be available: during the OFDM symbols of the subset of OFDM symbols mapped to the selected candidate code-block group; and in in the channels of the subset of the channels that is mapped to the selected candidate code-block group. One or more other criteria may be used, in addition to or instead of the criterion described above. One or more of the above may be performed as part of the LBT process, although the scope of embodiments is not limited in this respect.

In some embodiments, the TX node, gNB 105 and/or UE 102 may encode the multiple candidate code-block groups to be available for transmission in different portions of a subframe, wherein the subframe may include a plurality of orthogonal frequency division multiplexing (OFDM) symbols. In some embodiments, each of the candidate code-block groups may be further mapped to a different subset of the OFDM symbols, wherein at least some of the subsets of the OFDM symbols at least partly overlap. In some embodiments, the TX node, gNB 105 and/or UE 102 may, for each of the candidate code-block groups, determine an individual channel measurement for the candidate code-block group based on signals detected in: the one or more channels of the subset of channels to which the candidate code-block group is mapped, and the OFDM symbols in the subset of OFDM symbols to which the candidate code-block group is mapped. In some embodiments, the subsets of OFDM symbols may include contiguous OFDM symbols, although the scope of embodiments is not limited in this respect. One or more of the above may be performed as part of the LBT process, although the scope of embodiments is not limited in this respect.

At operation 830, the TX node, gNB 105 and/or UE 102 may receive a code-block group. In some embodiments, the UE 102 may receive the code-block group from the gNB 105. For instance, the UE 102 may receive the code-block group from the gNB 105 on the downlink. It should be noted that operation 830 may be separate from operations 810-825 (which may be related to uplink), although the scope of embodiments is not limited in this respect. For instance, the candidate code-block group selected at operation 820 may not be related to the received code-block group of operation 830. Some embodiments may not necessarily include all operations shown in FIG. 8.

At operation 835, the TX node, gNB 105 and/or UE 102 may determine one or more measurements. At operation 840, the TX node, gNB 105 and/or UE 102 may transmit a measurement report. At operation 845, the TX node, gNB 105 and/or UE 102 may receive control signaling that indicates whether a handover of the UE is to occur.

It should be noted that operations 835-845 may be separate from operations 810-830, although the scope of embodiments is not limited in this respect. For instance, the TX node, gNB 105 and/or UE 102 may perform one or more of operations 835-845, but may not necessarily perform any of operations 810-830, in some embodiments. Some embodiments may not necessarily include all operations shown in FIG. 8.

In some embodiments, the TX node, gNB 105 and/or UE 102 may determine per-channel measurements for a plurality of channels in the unlicensed spectrum. In some embodiments, the TX node, gNB 105 and/or UE 102 may determine, for each of the channels, one or more of: a per-channel RSSI, a per-channel channel occupancy measurement, an indicator of whether at least one WLAN device operates in the channel, and an indicator of whether at least one 3GPP LTE device operates in the channel. In some embodiments, the TX node, gNB 105 and/or UE 102 may determine wideband channel measurements. In some embodiments, the TX node, gNB 105 and/or UE 102 may determine, for a combined channel that includes the plurality of channels, one or more of: an RSSI, a channel occupancy measurement, an indicator of whether at least one WLAN device operates in the combined channel, and an indicator of whether at least one 3GPP LTE device operates in the channel.

In some embodiments, the TX node, gNB 105 and/or UE 102 may transmit, to the gNB 105, a measurement report that includes one or more of the per-channel measurements and/or one or more of the wideband measurements. In some embodiments, the UE 102 may receive, from the gNB 105, control signaling that indicates whether the UE 102 is to perform a handover to another channel of the plurality of channels based on the encoded measurement report. In some embodiments, the gNB 105 may determine whether the UE 102 is to perform the handover based at least partly on the measurement report.

In some embodiments, the TX node, gNB 105 and/or UE 102 may determine the per-channel RSSIs in accordance with an RSSI measurement timing configuration (RMTC) that indicates a periodicity of the RSSI measurement. In some embodiments, the TX node, gNB 105 and/or UE 102 may determine the per-channel channel occupancy measurements to indicate, for each of the channels, a percentage of time that the channel is occupied. In some embodiments, the TX node, gNB 105 and/or UE 102 may determine that the channel is occupied if a detected energy level in the channel is greater than a threshold.

In some embodiments, the TX node, gNB 105 and/or UE 102 may receive, from the gNB 105, control signaling that configures the RMTC. In a non-limiting example, the control signaling may configure the RMTC to be one of 40, 80, 160, 320, and 640 msec. Embodiments are not limited to the example values given above, as one or more other values may be used, in some embodiments.

In some embodiments, an apparatus of a TX node, gNB 105 and/or UE 102 may comprise memory. The memory may be configurable to store at least a portion of the candidate code-block groups. The memory may store one or more other elements and the apparatus may use them for performance of one or more operations. The apparatus may include processing circuitry, which may perform one or more operations (including but not limited to operation(s) of the method 800 and/or other methods described herein). The processing circuitry may include a baseband processor. The baseband circuitry and/or the processing circuitry may perform one or more operations described herein, including but not limited to encoding of the candidate code-block groups. The apparatus may include a transceiver to transmit the selected candidate code-block group. The transceiver may transmit and/or receive other blocks, messages and/or other elements.

At operation 905, the gNB 105 may transmit control signaling. At operation 910, the gNB 105 may encode candidate code-block groups. At operation 915, the gNB 105 may determine one or more channel measurements. At operation 920, the gNB 105 may select one of the candidate code-block groups. At operation 925, the gNB 105 may transmit the selected candidate code-block group. The gNB 105 may transmit the selected candidate code-block group on the downlink, although the scope of embodiments is not limited in this respect. At operation 930, the gNB 105 may receive a code-block group. The gNB 105 may receive the code-block group from the UE 102 on the uplink, although the scope of embodiments is not limited in this respect. In some embodiments, operation 930 may be separate from operations 910-925, although the scope of embodiments is not limited in this respect.

At operation 935, the gNB 105 may receive a measurement report. At operation 940, the gNB 105 may determine, based at least partly on the measurement report, whether the handover of the UE 102 is to occur. At operation 945, the gNB 105 may transmit control signaling that indicates whether the handover of the UE 102 is to occur. In some embodiments, operations 935-945 may be separate from operations 910-925, although the scope of embodiments is not limited in this respect.

In some embodiments, the gNB 105 may encode multiple candidate code-block groups to be available for a transmission in unlicensed spectrum comprising multiple channels and in a slot comprising multiple OFDM symbols, wherein one of the candidate code-block groups is to be transmitted based on an LBT process. In some embodiments, the multiple candidate code-block groups are to be available before the LBT process to enable the transmission to meet a target latency, although the scope of embodiments is not limited in this respect. In some embodiments, each of the candidate code-block groups may be mapped to a subset of the channels and may be mapped to a subset of the OFDM symbols. In some embodiments, for at least two of the candidate code-block groups: the corresponding subsets of the channels may be different and may at least partly overlap; and/or the corresponding subsets of the OFDM symbols may be different and may at least partly overlap. In some embodiments, the gNB 105 may, for each of the channels and for each of the OFDM symbols of the slot, perform one or more of: determine an availability of the channel for the transmission during the OFDM symbol; select one of the candidate code-block groups for the transmission based on the determined availabilities; and/or other. In some embodiments, the gNB 105 may select the candidate code-block group for the transmission based on a criterion that the channel is determined to be available: during the OFDM symbols of the subset of OFDM symbols mapped to the selected candidate code-block group; and in in the channels of the subset of the channels that is mapped to the selected candidate code-block group. One or more other criteria may be used, in addition to or instead of the criterion described above. One or more of the above may be performed as part of the LBT process, although the scope of embodiments is not limited in this respect.

In some embodiments, an apparatus of a gNB 105 may comprise memory. The memory may be configurable to store at least a portion of the candidate code-block groups. The memory may store one or more other elements and the apparatus may use them for performance of one or more operations. The apparatus may include processing circuitry, which may perform one or more operations (including but not limited to operation(s) of the method 900 and/or other methods described herein). The processing circuitry may include a baseband processor. The baseband circuitry and/or the processing circuitry may perform one or more operations described herein, including but not limited to encoding of the candidate code-block groups. The apparatus may include a transceiver to transmit the selected candidate code-block group. The transceiver may transmit and/or receive other blocks, messages and/or other elements.

FIGS. 10-13 illustrates example elements in the frequency domain and example elements in the time domain in accordance with some embodiments. FIG. 14 illustrates example elements in the frequency domain in accordance with some embodiments. It should be noted that the examples shown in FIGS. 10-14 may illustrate some or all of the concepts and techniques described herein in some cases, but embodiments are not limited by the examples. For instance, embodiments are not limited by the name, number, type, size, ordering, arrangement of elements (such as devices, operations, messages and/or other elements) shown in FIGS. 10-14. Although some of the elements shown in the examples of FIGS. 10-14 may be included in a 3GPP standard, 3GPP LTE standard, NR standard, 5G standard and/or other standard, embodiments are not limited to usage of such elements that are included in standards.

In some embodiments, a method for transmission BW and duration adaptation with channel availability uncertainty may be used. In 3GPP Rel-15, study on NR-based access to unlicensed spectrum have been started. It is noted that Rel-15 NR system is designed to operate on licensed spectrum. The NR-unlicensed, a short-hand notation of the NR-based access to unlicensed spectrum, is a technology that enables the operation of NR system on unlicensed spectrum.

Rel-15 NR system supports much wider maximum channel bandwidth (CBW) than LTE's 20 MHz. Wideband communication is also supported in LTE via CA of up to 20 MHz component carriers (CCs). By defining wider CBW in NR, it is possible to dynamically allocate frequency resources via scheduling, which can be more efficient and flexible than the CA operation. In addition, having single wideband carrier has a merit in terms of low control overhead as it needs only single control signaling, whereas CA requires separate control signaling per each aggregated carrier. Moreover, the spectrum utilization can be improved by eliminating the need of guardband between CCs.

Rel-15 NR system supports both type-A and type-B mappings, where type-A mapping refers to slot transmission and type-B mapping refers to mini-slot transmission. In Rel-14, type-B mappings of duration 2, 4, and 7 OSs are supported.

In performing LBT, there are two dimensions of uncertainty, i.e., frequency and time. For instance, for a wide channel BW in which LBT is performed in the unit of BW, it is possible that not all but only part of BW may succeed LBT. A non-limiting example 1000 in FIG. 10 illustrates wideband operation and LBT performed per unit BW. For instance, the LBT may be successful in the top two portions 1010 and 1020, and unsuccessful in the portion 1030.

Likewise, LBT can also finish anytime in between slot boundaries. A non-limiting example 1050 in FIG. 10 illustrates LBT in the time domain. The LBT may be successful in the portion 1060 and may be unsuccessful in the portion 1070.

In some embodiments, a method for transmission BW and duration adaptation may be used to cope with channel availability uncertainty in frequency and time due to LBT.

References are made herein to “method 1,” “method 2,” and “method 3,” but such references are not limiting. Such references may be made for clarity. It is understood that some embodiments may be based at least partly on method 1, method 2 and/or method 3. Some embodiments may be based at least partly on a combination of two or more of method 1, method 2, and method 3. Some embodiments may be based on aspects of one or more of method 1, method 2, and/or method 3.

In descriptions herein, references to transport blocks (TBs), and code-block groups are not limiting. An operation that includes usage of one of those elements (TB or code-block group) may be performed using the other element, in some embodiments. For instance, an operation may include usage of a TB in some embodiments, but a code-block group and/or other element may be used in the same operation (and/or similar operation) in other embodiments. In addition, an operation may include usage of a code-block group in some embodiments, but a TB and/or other element may be used in the same operation (and/or similar operation) in other embodiments.

In some embodiments (which may be referred to, without limitation, as method 1), multiple separate transport blocks (TBs) are prepared with the consideration of given unit LBT channel BW. For instance, if a wideband carrier is consisting of X number of unit LBT BW parts, multiple separate TBs are prepared assuming the frequency domain mapping in an integer multiple of 20 MHz BW parts. For example, three TBs can be prepared each for 20 MHz BW or one TB for 20 MHz and one TB for 40 MHz can be prepared for given 60 MHz BW. If number of TBs is less than the number of unit LBT BW, the mapping of each TB to frequency is up to implementation.

In some embodiments, multiple separate TBs are prepared with the consideration of possible transmission starting instances in time. For instance, if possible transmission instances are in the unit of K symbols, then multiple separate TBs are prepared assuming the time domain mapping in an integer multiple of K symbols. For instance, if transmission is allowed every 7 OS, then separate TB is mapped to each 7 OS. If the number of TB is less than the possible starting points in time, the TB mapping in time can start with a more finer granularity in the beginning of slot. In some embodiments, multiple separate TBs are prepared with the consideration of given unit LBT channel BW and possible transmission starting instances both in frequency and time. In some embodiments, a combination of the above embodiments may be used. In some embodiments, there could be a maximum number of TBs supported, N. In some embodiments, the method can be applied to either DL, UL or both DL/UL transmissions. In some embodiments, after performing LBT, transmission is performed for TBs mapped to frequency, time, or both frequency/time for which the CCA is succeeded. TBs mapped to frequency, time, or both frequency/time for which the CCA is failed are not transmitted.

In some embodiments (which may be referred to, without limitation, as method 2), multiple copies of TBs are prepared for possible hypothesis of LBT success in frequency with the consideration of given unit LBT channel BW. For instance, if a wideband carrier is consisting of X number of unit LBT BW parts, multiple copies of TBs are prepared for possible hypothesis of LBT success in frequency assuming the frequency domain mapping in an integer multiple of 20 MHz BW parts. For example, three TBs can be prepared each for 20 MHz, 40 MHz, and 60 MHz BW for given 60 MHz BW. In some embodiments, a combination of different frequency domain positions and integer multiple of 20 MHz can be assumed. If number of TBs is less than the number of unit LBT BW, the mapping of each TB to frequency is up to implementation.

In some embodiments, multiple copies of TBs are prepared for possible hypothesis of LBT success in time with the consideration of possible transmission starting instances. For instance, if possible transmission instances are in the unit of K symbols, then multiple copies of TBs are prepared for possible hypothesis of LBT success in time assuming possible transmission starting points assuming the time domain mapping in an integer multiple of K symbols. For instance, if transmission is allowed every 7 OS, then one TB can be prepared assuming 14 OS and another TB can be prepared assuming 7 OS. If the number of TB is less than the possible starting points in time, the several copies of TB mapping in time can be prepared for more finer granularity in the beginning of slot.

In some embodiments, multiple copies of TBs are prepared for possible hypothesis of LBT success in frequency with the consideration of given unit LBT channel BW and in time with the consideration of possible transmission starting instances. In some embodiments, a combination of the above embodiments may be used.

In some embodiments, there could be a maximum number of TBs supported, N. In some embodiments, the method can be applied to either DL, UL or both DL/UL transmissions. In some embodiments, after performing LBT, transmission is performed for TB mapped to frequency, time, or both frequency/time for which the CCA is succeeded. Other TBs assumed different hypothesis of LBT success are not transmitted.

In some embodiments (which may be referred to, without limitation, as method 3), for a given TB, code block group (CBG) segmentation is performed in frequency with the consideration of given unit LBT channel BW. For instance, if a wideband carrier is consisting of X number of unit LBT BW parts, for a given TB, CBG segmentation is performed assuming the frequency domain mapping in an integer multiple of 20 MHz BW parts. For example, each CBG can be mapped to each of 20 MHz for given 60 MHz BW. Different combinations of different frequency domain positions and integer multiple of 20 MHz can be assumed. If number of CBSs is less than the number of unit LBT BW, the mapping of each CBG to frequency is up to implementation.

In some embodiments, for a given TB, CBG segmentation is performed in time with the consideration of possible transmission starting instances. For instance, if possible transmission instances are in the unit of K symbols, CBG segmentation is performed assuming the possible transmission starting points in time with mapping in an integer multiple of K symbols. For instance, if transmission is allowed every 7 OS, then each CBG is mapped to each 7 OS. If the number of CBGs is less than the possible starting points in time, the mapping of CBGs in time can start with finer granularity in the beginning of slot. For a given TB, CBG segmentation is performed both in frequency with the consideration of given unit LBT channel BW and in time with the consideration of possible transmission starting instances. In some embodiments, a combination of the above embodiments may be used. In some embodiments, there could be a maximum number of CBGs per TB supported, N. The method can be applied to either DL, UL or both DL/UL transmissions. In some embodiments, after performing LBT, transmission is performed for a given TB, only the CBGs mapped to frequency, time, or both frequency/time for which the CCA is succeeded. Other CBGs in the TB for which the CCA fails are not transmitted.

In some embodiments, transmissions in the form of TB are prepared earlier in time before transmission. The dynamic adaptation of transmission BW and duration is challenging due to time budget issue. Some embodiments described herein may provide solutions for transmission BW and duration adaptation while not requiring instant reproduction of transmissions.

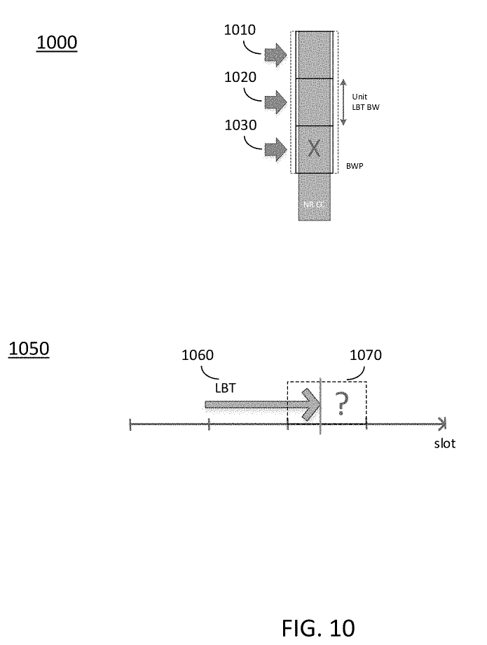

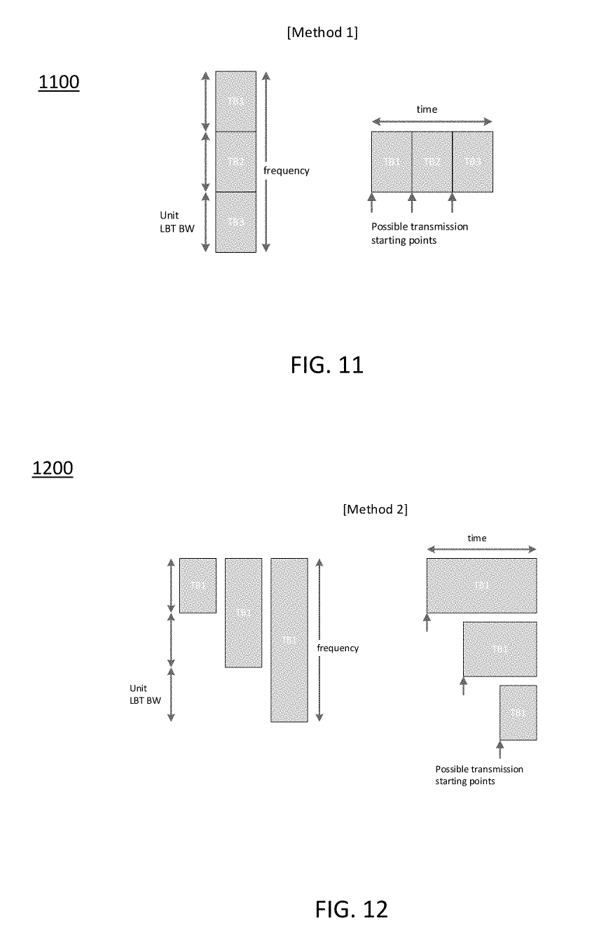

In some embodiments (which may be related to method 1), separate TB mapping for unit LBT BW and possible transmission starting points may be used. A non-limiting example 1100 is shown in FIG. 11. In some embodiments, multiple separate transport blocks (TBs) are prepared with the consideration of given unit LBT channel BW. For instance, if a wideband carrier is consisting of X number of unit LBT BW parts, multiple separate TBs are prepared assuming the frequency domain mapping in an integer multiple of 20 MHz BW parts. For example, three TBs can be prepared each for 20 MHz BW or one TB for 20 MHz and one TB for 40 MHz can be prepared for given 60 MHz BW. If number of TBs is less than the number of unit LBT BW, the mapping of each TB to frequency is up to implementation.

In some embodiments, multiple separate TBs are prepared with the consideration of possible transmission starting instances in time. For instance, if possible transmission instances are in the unit of K symbols, then multiple separate TBs are prepared assuming the time domain mapping in an integer multiple of K symbols. For instance, if transmission is allowed every 7 OS, then separate TB is mapped to each 7 OS. If the number of TB is less than the possible starting points in time, the TB mapping in time can start with finer granularity in the beginning of slot.

In some embodiments, multiple separate TBs are prepared with the consideration of given unit LBT channel BW and possible transmission starting instances both in frequency and time. In some embodiments, a combination of the above embodiments may be used.

In some embodiments, there could be a maximum number of TBs supported, N. The method can be applied to either DL, UL or both DL/UL transmissions. After performing LBT, transmission is performed for TBs mapped to frequency, time, or both frequency/time for which the CCA is succeeded. TBs mapped to frequency, time, or both frequency/time for which the CCA is failed are not transmitted.

In some embodiments (which may be related to method 2), multiple copies of TB preparation for possible hypothesis of LBT success in frequency/time may be used. A non-limiting example 1200 in FIG. 12 illustrates this concept. Multiple copies of TBs are prepared for possible hypothesis of LBT success in frequency with the consideration of given unit LBT channel BW. For instance, if a wideband carrier is consisting of X number of unit LBT BW parts, multiple copies of TBs are prepared for possible hypothesis of LBT success in frequency assuming the frequency domain mapping in an integer multiple of 20 MHz BW parts. For example, three TBs can be prepared each for 20 MHz, 40 MHz, and 60 MHz BW for given 60 MHz BW. Different combinations of different frequency domain positions and integer multiple of 20 MHz can be assumed. If number of TBs is less than the number of unit LBT BW, the mapping of each TB to frequency is up to implementation.

In some embodiments, multiple copies of TBs are prepared for possible hypothesis of LBT success in time with the consideration of possible transmission starting instances. For instance, if possible transmission instances are in the unit of K symbols, then multiple copies of TBs are prepared for possible hypothesis of LBT success in time assuming possible transmission starting points assuming the time domain mapping in an integer multiple of K symbols. For instance, if transmission is allowed every 7 OS, then one TB can be prepared assuming 14 OS and another TB can be prepared assuming 7 OS. If the number of TB is less than the possible starting points in time, the several copies of TB mapping in time can be prepared for a more finer granularity in the beginning of slot.

In some embodiments, multiple copies of TBs are prepared for possible hypothesis of LBT success in frequency with the consideration of given unit LBT channel BW and in time with the consideration of possible transmission starting instances. In some embodiments, a combination of the above embodiments may be used. In some embodiments, there could be a maximum number of TBs supported, N. The method can be applied to either DL, UL or both DL/UL transmissions. After performing LBT, transmission is performed for TB mapped to frequency, time, or both frequency/time for which the CCA is succeeded. Other TBs assumed different hypothesis of LBT success are not transmitted.

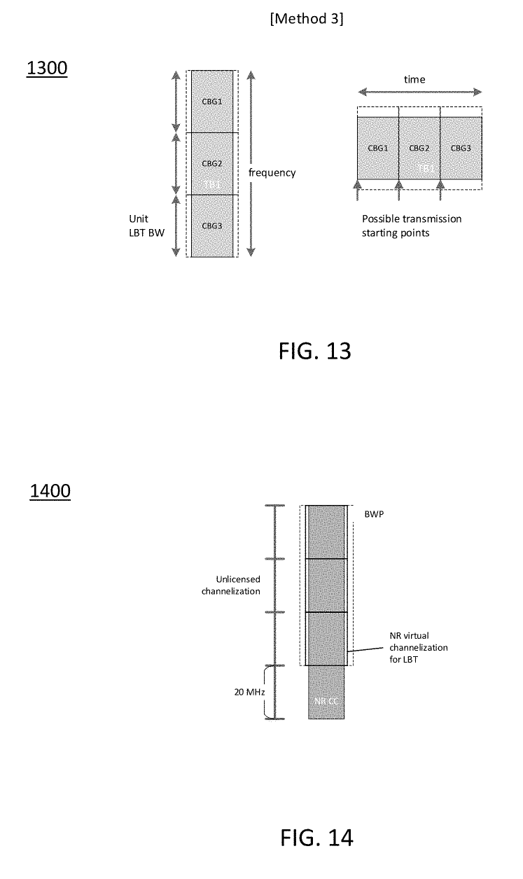

In some embodiments (which may be related to method 3), codeblock group (CBG) segmentation for unit LBT BW and possible transmission starting points may be used. A non-limiting example 1300 in FIG. 13 illustrates this concept. For a given TB, code block group (CBG) segmentation is performed in frequency with the consideration of given unit LBT channel BW. For instance, if a wideband carrier is consisting of X number of unit LBT BW parts, for a given TB, CBG segmentation is performed assuming the frequency domain mapping in an integer multiple of 20 MHz BW parts. For example, each CBG can be mapped to each of 20 MHz for given 60 MHz BW. Different combinations of different frequency domain positions and integer multiple of 20 MHz can be assumed. If number of CBSs is less than the number of unit LBT BW, the mapping of each CBG to frequency is up to implementation.

In some embodiments, for a given TB, CBG segmentation is performed in time with the consideration of possible transmission starting instances. For instance, if possible transmission instances are in the unit of K symbols, CBG segmentation is performed assuming the possible transmission starting points in time with mapping in an integer multiple of K symbols. For instance, if transmission is allowed every 7 OS, then each CBG is mapped to each 7 OS. If the number of CBGs is less than the possible starting points in time, the mapping of CBGs in time can start with finer granularity in the beginning of slot.

In some embodiments, for a given TB, CBG segmentation is performed both in frequency with the consideration of given unit LBT channel BW and in time with the consideration of possible transmission starting instances. In some embodiments, a combination of the above embodiments may be used.

In some embodiments, there could be a maximum number of CBGs per TB supported, N. The method can be applied to either DL, UL or both DL/UL transmissions. After performing LBT, transmission is performed for a given TB, only the CBGs mapped to frequency, time, or both frequency/time for which the CCA is succeeded. Other CBGs in the TB for which the CCA fails are not transmitted.

In 3GPP Rel-15, study on NR-based access to unlicensed spectrum have been started. It is noted that Rel-15 NR system is designed to operate on licensed spectrum. The NR-unlicensed, a short-hand notation of the NR-based access to unlicensed spectrum, is a technology that enables the operation of NR system on unlicensed spectrum.

In the unlicensed operation, there is a need for the introduction of new measurement/reports in addition to the conventional measurements/reports defined for licensed operation, e.g., RSRP, RSRQ, etc.

New measurement reports can be beneficial for unlicensed band channel selection to choose a channel that is currently less congested. The channel selection can be made more elaborated by taking into account of the presence of other technologies sharing the same spectrum.

On the other hand, rel-15 NR system supports much wider maximum channel bandwidth (CBW) than LTE's 20 MHz. Wideband communication is also supported in LTE via CA of up to 20 MHz component carriers (CCs). By defining wider CBW in NR, it is possible to dynamically allocate frequency resources via scheduling, which can be more efficient and flexible than the CA operation. In addition, having single wideband carrier has a merit in terms of low control overhead as it needs only single control signaling, whereas CA requires separate control signaling per each aggregated carrier. Moreover, the spectrum utilization can be improved by eliminating the need of guardband between CCs.

For a given wide CBW, it may be beneficial to perform measurement/report not only for the wideband but also in the unit of sub-bands in the consideration of Wi-Fi 20 MHz channelization.

In some embodiments, NR RRM enhancements for unlicensed band operation may be used. In some embodiments, various enhancements to NR RRM may be used to enhance the unlicensed band operation.

In some embodiments, one or more of the following measurements/reports are supported for NR: RSSI measurement/report; channel occupancy measurement/report; measurement/report on the presence of other technologies (e.g., Wi-Fi systems including but not limited to IEEE 802.11a/b/g/n/ac/ax/ad/ay, and/or LTE unlicensed including but not limited to LAA/eLAA/FeLAA, MuLTEfire, etc.); measurement/report on the presence of same NR-unlicensed technology; measurement/report on the RSSI/channel occupancy from signals of the same operator networks is supported for NR; and/or other.

In some embodiments, for the above listed measurements/reports, one or more of the following reporting options may be supported: instantaneous and/or average measurement reports; quantized measurement report; wide-band and sub-band measurement report; and/or other.

In some embodiments, the measurements/reports can be utilized by the network for unlicensed channel selection.

In some embodiments, one or more of the techniques, operations and/or methods described herein may aim to enhance NR RRM measurement that can be potentially used by the network for unlicensed channel selection, etc. The details of the embodiments are described below.

In some embodiments, RSSI measurement/report is supported. RSSI measurement timing configuration (RMTC) is introduced. RMTC has configurable periodicity and may take values from {40, 80, 160, 320, 640} ms. In the absence of RMTC configuration, a UE 102 may autonomously select the timing for inter-frequency measurements.

In some embodiments, channel occupancy measurement/report is supported. The measurement report is in the form of percentage that the channel is being occupied. Channel is measured as being occupied if the detected energy level is above a certain threshold. The threshold is signaled to UE 102. The threshold is a fixed constant value, e.g., −72 dBm. The threshold is ED threshold value of the UE 102 based on the transmission power. A system-specific measurement can be also used such as Wi-Fi preamble detection, LTE CRS detection, and NR RS detection including signals that may introduced later, e.g., NR preamble, etc.

In some embodiments, measurement/report on the presence of other technologies (e.g., Wi-Fi systems including but not limited to IEEE 802.11a/b/g/n/ac/ax/ad/ay, and/or LTE unlicensed including but not limited to LAA/eLAA/FeLAA, MuLTEfire, etc.) is supported. For the measurement of the presence of Wi-Fi technologies, Wi-Fi preamble detection is used. For the measurement of the presence of LTE unlicensed technologies, CRS detection is used.

In some embodiments, measurement/report on the presence of same NR-unlicensed technology is supported. NR RS detection including signals that may introduced later, e.g., NR preamble, etc.

In some embodiments, measurement/report on the RSSI/channel occupancy from signals of the same operator networks is supported for NR.

In some embodiments, for the above listed measurements/reports, one or more of the following reporting options are supported. In some embodiments, instantaneous and/or average measurement reports are supported. L1 measurement is performed over X number of symbols, e.g., 1. L1 measurement is aggregated over certain duration, e.g., N number of L1 measurements or T ms, to produce average measurement. In some embodiments, quantized measurement report is supported. For instance the measured values are quantized over M ranges of values and the index of the corresponding range is reported. In some embodiments, wide-band and sub-band measurement report is supported. The motivation is because NR supports wideband operation and the measurement can be quite different in the different parts of the spectrum within the wideband carrier.

A non-limiting example 1400 in FIG. 14 illustrates NR wide channel bandwidth.

For instance, if measurement is performed for a wide channel BW, e.g., 100 MHz, both wide-band measurement for 100 MHz and sub-band measurement for each five 20 MHz BW is supported. The BW that the sub-band measurement is performed can be aligned with LBT BW grid.

In some embodiments, one or more of the following measurements/reports may be supported for NR. In some embodiments, an RSSI measurement/report may be used. For the RSSI measurement/report, an RSSI measurement timing configuration (RMTC) may be used. In some embodiments, the RMTC may have a configurable periodicity. Non-limiting example values of the periodicity may include values from {40, 80, 160, 320, 640} ms. In some embodiments, other values/ranges are possible. In some embodiments, in the absence of RMTC configuration, a UE 102 may autonomously select the timing for inter-frequency measurements.

In some embodiments, a channel occupancy measurement/report may be used. In some embodiments, the channel occupancy measurement/report may be in the form of percentage that the channel is being occupied. In some embodiments, the channel may be measured as being occupied if the detected energy level is above a certain threshold. In some embodiments, the threshold may be signaled to the UE 102. In some embodiments, the threshold may be a fixed constant value, e.g., −72 dBm. Other values are possible. In some embodiments, the threshold may be an ED threshold value of the UE 102 based on the transmission power. In some embodiments, a system-specific measurement can be also used such as Wi-Fi preamble detection, LTE CRS detection, and NR RS detection including signals that may introduced later, e.g., NR preamble, etc.

In some embodiments, a measurement/report on the presence of other technologies (e.g., Wi-Fi systems including but not limited to IEEE 802.11a/b/g/n/ac/ax/ad/ay, and/or LTE unlicensed including but not limited to LAA/eLAA/FeLAA, MuLTEfire, etc.) may be used. In some embodiments, for the measurement of the presence of Wi-Fi technologies, Wi-Fi preamble detection is used. In some embodiments, for the measurement of the presence of LTE unlicensed technologies, CRS detection may be used.

In some embodiments, a measurement/report on the presence of same NR-unlicensed technology may be used. In some embodiments, NR RS detection including signals that may introduced later, e.g., NR preamble, etc. may be used.

In some embodiments, a measurement/report on the RSSI/channel occupancy from signals of the same operator networks may be supported for NR.

In some embodiments, for measurements/reports (including but not limited to those described herein), one or more of the following reporting options may be supported. In some embodiments, instantaneous and/or average measurement reports may be used. In some embodiments, an L1 measurement may be performed over X number of symbols, e.g., 1. In some embodiments, an L1 measurement may be aggregated over certain duration, e.g., N number of L1 measurements or T ms, to produce average measurement. In some embodiments, a quantized measurement report may be used.

In some embodiments, a wide-band and sub-band measurement report may be used. For instance, if measurement is performed for a wide channel BW, e.g., 100 MHz, both wide-band measurement for 100 MHz and sub-band measurement for each five 20 MHz BW may be supported. In some embodiments, the BW that the sub-band measurement is performed can be aligned with LBT BW grid.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of a transmit (TX) node, the apparatus comprising: memory; and processing circuitry, configured to:
encode multiple candidate code-block groups to be available for a transmission in unlicensed spectrum, wherein one of the candidate code-block groups is to be transmitted based on a listen-before-talk (LBT) process,
wherein the unlicensed spectrum comprises multiple channels, wherein each of the candidate code-block groups is mapped to a different subset of the channels, wherein at least some of the subsets of the channels at least partly overlap;
as part of the LBT process:
determine one or more channel measurements of the channels;
determine, based on the channel measurements, one or more of the channels that are available for the transmission; and
select the candidate code-block group to be transmitted based on a criterion that the subset of the channels that is mapped to the selected candidate code-block group is included in the one or more channels that are available for the transmission,
wherein the memory is configured to store at least a portion of the candidate code-block groups.

2. The apparatus according to claim 1, the processing circuitry further configured to:
encode the multiple candidate code-block groups to be available before the LBT process to enable the transmission in accordance with a target latency.

3. The apparatus according to claim 1, wherein at least some of the subsets of the channels include different numbers of channels.

4. The apparatus according to claim 1, wherein:
the unlicensed spectrum comprises a first channel of 20 MHz, a second channel of 20 MHz, and a third channel of 20 MHz,
the processing circuitry is configured to encode:
a first code-block group that is mapped to the first channel,
a second code-block group that is mapped to the first channel and the second channel, and
a third code-block group that is mapped to the first channel, the second channel, and the third channel.

5. The apparatus according to claim 1, the processing circuitry further configured to:
for each of the channels:
determine an individual channel measurement of the channel;
if the individual channel measurement of the channel is less than a threshold, include the channel in the one or more channels that are available for the transmission; and
if the individual channel measurement of the channel is greater than or equal to the threshold, exclude the channel from the one or more channels that are available for the transmission.

6. The apparatus according to claim 1, wherein the channel measurements are based on an average power level, at the TX node, of signals detected from other TX nodes and/or other devices.

7. The apparatus according to claim 1, the processing circuitry further configured to:
if multiple candidate code-block groups meet the criterion:
determine a maximum number of channels mapped to the multiple candidate code-block groups that meet the criterion; and
select the candidate code-block group as a candidate code-block group that meets the criterion and for which the number of channels mapped to the selected candidate code-block group is equal to the maximum number of channels.

8. The apparatus according to claim 1, the processing circuitry further configured to:
encode the multiple candidate code-block groups to be available for transmission in different portions of a subframe, wherein the subframe includes a plurality of orthogonal frequency division multiplexing (OFDM) symbols,
wherein each of the candidate code-block groups is further mapped to a different subset of the OFDM symbols, wherein at least some of the subsets of the OFDM symbols at least partly overlap.

9. The apparatus according to claim 8, the processing circuitry further configured to:
as part of the LBT process:
for each of the candidate code-block groups, determine an individual channel measurement for the candidate code-block group based on signals detected in:
the one or more channels of the subset of channels to which the candidate code-block group is mapped, and
the OFDM symbols in the subset of OFDM symbols to which the candidate code-block group is mapped.

10. The apparatus according to claim 9, wherein the subsets of OFDM symbols include contiguous OFDM symbols.

11. The apparatus according to claim 1, the processing circuitry further configured to:
encode the candidate code-block groups based on information bits,
wherein at least some of the candidate code-block groups are based on different numbers of information bits.

12. The apparatus according to claim 1, wherein the channel measurements include:
one or more sub-band measurements based on signals detected in individual channels, and
one or more wideband measurements based on signals detected in an aggregate bandwidth that includes the multiple channels.

13. The apparatus according to claim 1, wherein the channel measurements are based on one or more of: a received signal strength indicator (RSSI), a channel occupancy, a presence of one or more Third Generation Partnership Project (3GPP) devices operating in the unlicensed spectrum, and a presence of one or more non-3GPP devices operating in the unlicensed spectrum.

14. The apparatus according to claim 1, wherein the TX node is arranged to operate in accordance with a new radio (NR) protocol.

15. The apparatus according to claim 1, wherein:
the apparatus includes a transceiver to transmit the selected candidate code-block group,
the processing circuitry includes a baseband processor to encode the candidate code-block groups.

16. A non-transitory computer-readable storage medium that stores instructions for execution by processing circuitry of a Generation Node-B (gNB), the operations to configure the processing circuitry to:
encode multiple candidate code-block groups to be available for a transmission in unlicensed spectrum comprising multiple channels and in a slot comprising multiple orthogonal frequency division multiplexing (OFDM) symbols,
wherein one of the candidate code-block groups is to be transmitted based on a listen-before-talk (LBT) process, wherein the multiple candidate code-block groups are to be available before the LBT process to enable the transmission to meet a target latency
wherein each of the candidate code-block groups is mapped to a subset of the channels and is mapped to a subset of the OFDM symbols,
wherein for at least two of the candidate code-block groups:
the corresponding subsets of the channels are different and at least partly overlap, or
the corresponding subsets of the OFDM symbols are different and at least partly overlap,
as part of the LBT process:
for each of the channels and for each of the OFDM symbols of the slot, determine an availability of the channel for the transmission during the OFDM symbol; and
select one of the candidate code-block groups for the transmission based on the determined availabilities.

17. The non-transitory computer-readable storage medium according to claim 16, the operations to further configure the processing circuitry to:
as part of the LBT process, select the candidate code-block group for the transmission based on a criterion that the channel is determined to be available:
during the OFDM symbols of the subset of OFDM symbols mapped to the selected candidate code-block group, and
in the channels of the subset of the channels that is mapped to the selected candidate code-block group.

18. An apparatus of a User Equipment (UE), the UE configured to communicate in unlicensed spectrum in accordance with a new radio (NR) protocol, the apparatus comprising: memory; and processing circuitry, configured to:
determine per-channel measurements for a plurality of channels in the unlicensed spectrum, wherein the processing circuitry is configured to determine, for each of the channels:
a per-channel received signal strength indicator (RSSI), a per-channel channel occupancy measurement, an indicator of whether at least one wireless local area network (WLAN) device operates in the channel, and an indicator of whether at least one Third Generation Partnership Project Long Term Evolution (3GPP LTE) device operates in the channel;
determine wideband channel measurements, wherein the processing circuitry is configured to determine, for a combined channel that includes the plurality of channels:
an RSSI, a channel occupancy measurement, an indicator of whether at least one WLAN device operates in the combined channel, and an indicator of whether at least one 3GPP LTE device operates in the channel;
encode, for transmission to a Next Generation Node-B (gNB), a measurement report that includes the per-channel measurements and the wideband measurements; and
decode, from the gNB, control signaling that indicates whether the UE is to perform a handover to another channel of the plurality of channels based on the encoded measurement report,
wherein the memory is configured to store information related to the per-channel measurements.

19. The apparatus according to claim 18, the processing circuitry further configured to:
determine the per-channel RSSIs in accordance with an RSSI measurement timing configuration (RMTC) that indicates a periodicity of the RSSI measurement;
determine the per-channel channel occupancy measurements to indicate, for each of the channels, a percentage of time that the channel is occupied, wherein the channel is occupied if a detected energy level in the channel is greater than a threshold.

20. The apparatus according to claim 19, the processing circuitry further configured to:
decode, from the gNB, control signaling that configures the RMTC to be one of 40, 80, 160, 320, and 640 msec.
